(19) United States
(12) Patent Application Publication
(10) Pub. No.: US 2013/0013127 A1
(43) Pub. Date: Jan. 10, 2013

(54) NETWORK INTERFACE FOR USE IN VEHICLES

(76) Inventor: Andrew G. Weinberg, Campbell, CA (US)

(21) Appl. No.: 13/535,646

(22) Filed: Jun. 28, 2012

Related U.S. Application Data
(60) Provisional application No. 61/504,940, filed on Jul. 6, 2011.

(51) Int. Cl. G06F 17/00

(52) U.S. Cl. 701/1

(57) ABSTRACT

An apparatus is set forth for use with a vehicle having a first electronic control unit and a second electronic control unit. The apparatus comprises data processing circuitry in data communication with memory circuitry and input/output circuitry. The data processing circuitry, the memory circuitry, and the input/output circuitry are collectively operative to: (a) receive an input message from the first electronic control unit over a first network where the input message is formatted in conformity with a first messaging protocol; (b) translate the input message into a corresponding output message formatted in accordance with a second messaging protocol where the second messaging protocol is different from the first messaging protocol; and (c) transmit the corresponding output message to the second electronic control unit over a second network. The first and second electronic control units are operative to control and/or sense one or more elements within the vehicle.

### FIELD OF THE INVENTION

The present invention relates generally to electronic devices, and, more particularly, to electronic devices used to control vehicles.

### BACKGROUND OF THE INVENTION

Automobile enthusiasts often find it desirable to replace original components in their automobiles with components produced by different manufacturers (i.e., non original-equipment-manufacturer (OEM) components). It is known, for example, that replacing the original engines in older European automobiles from BMW (Munich, Germany), MERCEDES (Stuttgart, Germany), and JAGUAR (Whitley, Coventry, UK) with engines manufactured by GENERAL MOTORS (Detroit, Mich., USA) tends to have a very positive impact on performance and reliability. Doing so may also substantially extend the useful lives of those automobiles.

Nevertheless, as the electrical aspects of automobiles become more complex, the replacement of original components with non-OEM components becomes increasingly more difficult. A modern automobile may have as many as 70 electronic control units (ECUs) for managing various subsystems. ECUs may be used to control, sense, and communicate information about an automobile's engine, transmission, airbags, antilock brake system (ABS), cruise control, electric power steering, audio system, windows, doors, mirrors, and the like. Adding a non-OEM component such as a non-OEM engine to an automobile therefore requires that the automobile be configured so that the new component is able to interface effectively with other subsystems within that automobile. In order for an automobile to function properly, a replacement engine may for example, be required to communicate with ECUs controlling the automobile's transmission, brakes, instrument cluster, and various other subsystems.

Communications among ECUs in automobiles is typically performed with networks utilizing the controller area network (CAN) protocol. The CAN protocol is an ISO standard (presently ISO 11898) for serial data communication. It is described in detail in, for example, W. Voss, A Comprehensible Guide to Controller Area Network, Copperhill Media, 2005, which is hereby incorporated herein by reference. Each ECU (i.e., node) on a CAN network is able to send and receive messages. A CAN message frame typically includes an identifier and up to eight bytes of data. Messages are transmitted serially into the network. In the case where two ECUs transmit at the same time, priority is determined based on identifiers. Interconnection between two nodes is typically accomplished with two wires (e.g., a twisted pair), one transmitting “CAN-high” (CANH) signals and the other transmitting “CAN-low” (CANL) signals, to create a two-wire balanced signaling scheme.

Unfortunately, the content of the messages transmitted over CAN networks tends to differ from one automobile manufacturer to another (i.e., each automobile manufacturer utilizes a different messaging protocol). Moreover, in many cases, the messaging protocols are kept proprietary. The implementation of non-OEM components in modern automobiles utilizing CAN networks therefore remains challenging.

### SUMMARY OF THE INVENTION

Embodiments of the present invention address the above-identified needs by providing apparatus and methods for use in vehicles that allow a first electronic control unit that communicates using a given messaging protocol on a given network to effectively communicate with a second electronic control unit that communicates using a different messaging protocol on a different network.

Aspects of the invention are directed to an apparatus for use with a vehicle having a first electronic control unit and a second electronic control unit. The apparatus comprises data processing circuitry in data communication with memory circuitry and input/output circuitry. So configured, the data processing circuitry, the memory circuitry, and the input/output circuitry are collectively operative to: (a) receive an input message from the first electronic control unit over a first network where the input message is formatted in conformity with a first messaging protocol; (b) translate the input message into a corresponding output message formatted in accordance with a second messaging protocol where the second messaging protocol is different from the first messaging protocol; and (c) transmit the corresponding output message to the second electronic control unit over a second network. The first electronic control unit, in turn, is operative to control and/or sense one or more first elements within the vehicle, while the second electronic control unit is operative to control and/or sense one or more second elements within the vehicle.

Additional aspects of the invention are directed to a vehicle that comprises data processing circuitry, memory circuitry, input/output circuitry, a first electronic control unit, and a second electronic control unit. Both the memory circuitry and the input/output circuitry are in data communication with the data processing circuitry, while the first electronic control unit is operative to control and/or sense one or more first elements within the vehicle and the second electronic control unit is operative to control and/or sense one or more second elements within the vehicle. So configured, the data processing circuitry, the memory circuitry, and the input/output circuitry are collectively operative to: (a) receive an input message from the first electronic control unit over a first network where the input message is formatted in conformity with a first messaging protocol; (b) translate the input message into a corresponding output message formatted in accordance with a second messaging protocol where the second messaging protocol is different from the first messaging protocol; and (c) transmit the corresponding output message to the second electronic control unit over a second network.

Even more aspects of the invention are directed to a method for controlling a vehicle having a first electronic control unit and a second electronic control unit. The method is performed by data processing circuitry in data communication with memory circuitry and input/output circuitry. The method comprises the steps of: a) receiving an input message from the first electronic control unit over a first network where the input message is formatted in conformity with a first messaging protocol; (b) translating the input message into a corresponding output message formatted in accordance with a second messaging protocol where the second messaging protocol is different from the first messaging protocol; and (c) transmitting the corresponding output message to the second electronic control unit over a second network. The first electronic control unit is operative to control and/or sense one or more first elements within the vehicle, while the second electronic control unit is operative to control and/or sense one or more second elements within the vehicle.

### BRIEF DESCRIPTION OF THE DRAWINGS

These and other features, aspects, and advantages of the present invention will become better understood with regard to the following description, appended claims, and accompanying drawings where:

FIG. 1 shows a block diagram of at least a portion of a data communication network within an automobile in accordance with a first illustrative embodiment of the invention;

FIG. 2 shows a block diagram of several elements that may be found within a network interface unit in the FIG. 1 data communication network, in accordance with an illustrative embodiment of the invention;

FIG. 3 shows a flowchart of a method for configuring the FIG. 2 network interface unit, in accordance with an illustrative embodiment of the invention;

FIGS. 4 and 5 show flowcharts of methods for operating the FIG. 2 network interface unit, in accordance with illustrative embodiments of the invention;

FIG. 6 shows a block diagram of at least a portion of a data communication network within an automobile in accordance with a second illustrative embodiment of the invention; and

FIG. 7 shows a block diagram of several elements that may be found within a network interface unit in the FIG. 6 data communication network, in accordance with an illustrative embodiment of the invention.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

The term “network” as used herein is intended to encompass any interfacing technology that allows the sharing of data between electronic devices. Thus, it is intended that the term “network” would encompass, but not be limited to, serial port connections, as well as those interfaces that function in accordance with protocols commonly associated with the physical layer in the Open Systems Interconnection (OSI) Model (e.g., Universal Serial Bus (USB), Ethernet, CAN, etc.).

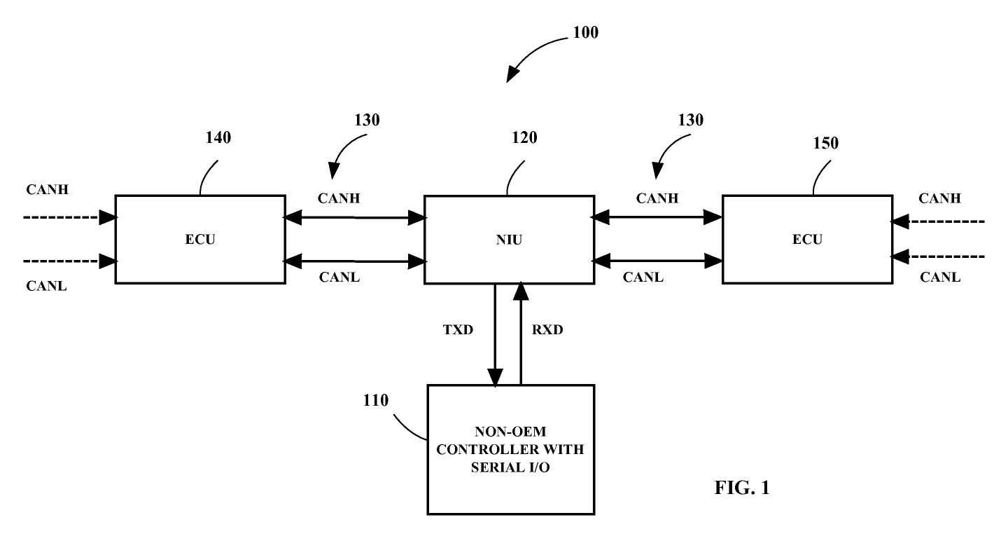

FIG. 1 shows a block diagram of at least a portion of a data communication network 100 within an automobile in accordance with a first illustrative embodiment of the invention. For purposes of illustrating aspects of the invention, the particular data communication network 100 is configured to accommodate an engine controller 110 acting to manage a non-OEM engine within the vehicle. A network interface unit (NIU) 120 interfaces the engine controller 110 with a CAN-based network 130. This CAN network 130, in turn, ties together several ECUs, of which, only a first ECU 140 and a second ECU 150 are explicitly shown.

As described above, it is frequently the case that the message coding utilized in a particular manufacturer's equipment is manufacturer specific (i.e., each manufacturer's equipment utilizes a different messaging protocol). Accordingly, it is assumed for this example, that the engine controller 110, being from a different manufacturer than the remainder of the automobile, is unable to produce coded messages that would be recognized by the ECUs 140, 150 in the CAN network 130, and vice versa. Furthermore, for purposes of describing aspects of the invention, it is further assumed that the engine controller 110 provides a non-CAN-compliant output, in this particular case, a serial-port-type output in conformity with, for example, the RS-232 protocol. The engine controller 110 is therefore also not able to directly interface with the wiring of the CAN network 130.

Advantageously, aspects of the invention address both of these deficiencies. The NIU 120 is preferably operative to translate messages initiated by the engine controller 110 that are formatted in conformity with the messaging protocol utilized by the engine controller 110 (hereinafter “engine controller messages”) into messages in conformity with the different messaging protocol utilized by the CAN network 130 (hereinafter “CAN messages”), and to then transmit these newly created CAN messages onto the CAN network 130. Likewise, the NIU 120 is also preferably operative to function in the reverse manner, namely, to take messages from the CAN network 130 that are relevant to the engine controller 110 and to format and transmit those messages in a manner that allows the engine controller 110 to receive and recognize those messages.

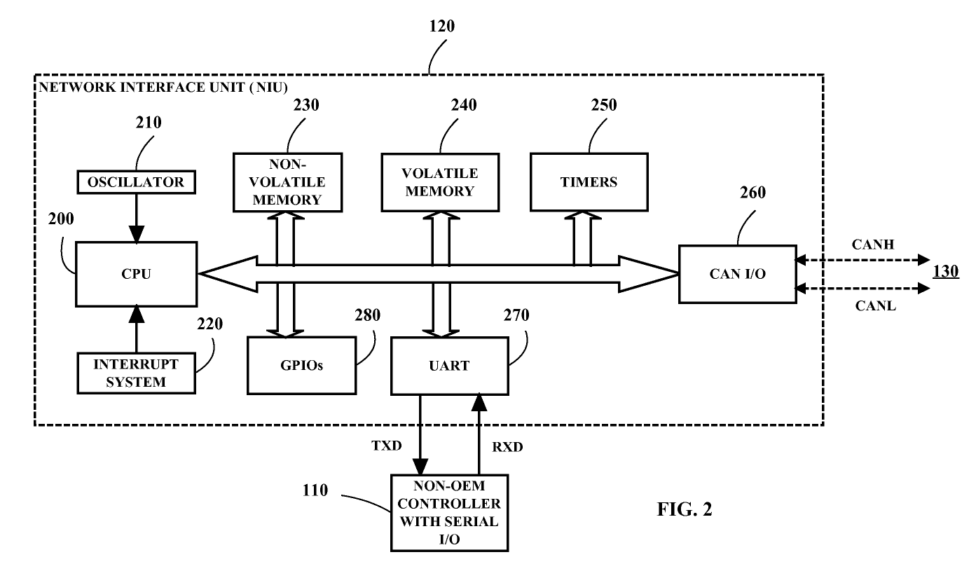

Once the novel functionality of the NIU 120 is understood, one skilled in the electronics arts will recognize that this functionality may be implemented in several different physical forms. FIG. 2 shows a block diagram of several elements that may be found within the NIU 120, in accordance with an illustrative embodiment of the invention. In the present example, these elements are physically implemented in a single integrated circuit as a microcontroller, but other physical implementations (e.g., as a plurality of discrete elements) would also fall within the scope of the invention. The NIU 120 comprises a central processing unit (CPU) 200 (more generally, a data processing unit) that may receive signals from an oscillator source 210 and an interrupt system 220. The NIU 120 further comprises a nonvolatile memory 230, a volatile memory 240, timers 250, a CAN interface 260, a Universal Asynchronous Receiver Transmitter (UART) 270, and general purpose input/output pins (GPIOs) 280. In the present embodiment, the UART 270 is tied to the engine controller 110 through a serial-port-type connection represented by transmit and receive lines TXD and RXD, respectively. The CAN interface 260 is tied to both the CANH and CANL lines of the CAN network 130.

Because the elements within the NIU 120 are largely conventional, they will be familiar to one skilled in the art. Moreover, microcontrollers are described in several readily available references, including K. J. Ayala, The 8051 Microcontroller, Cengage Learning, 2004, which is hereby incorporated by reference herein. Very generally, the CPU 200 may be operative perform logic and management functions, and may comprise its own memory portions (e.g., registers and CPU cache). The oscillator source 210, in turn, may be operative to provide a clock signal to the CPU 200, while the interrupt system 220 may be operative to provide interrupt signals to the CPU 200. The nonvolatile memory 230 and the volatile memory 240 may be operative to store program instructions, operating parameters, and data. The nonvolatile memory 230 may comprise, for example, read-only memory (ROM) such as mask-programmed ROM, programmable ROM (PROM), erasable PROM (EPROM), electrically-erasable PROM (EEPROM), flash memory, or a combination thereof. The volatile memory 240 may, for example, comprise random access memory (RAM) such as dynamic RAM (DRAM), static RAM (SRAM), or a combination thereof. The timers 250 may act as timers or counters for the NIU 120, while the CAN interface 260 may allow the NIU 120 to interconnect with a CAN network. The UART 270 may allow serial input/output such as serial port type connections. Lastly, the GPIOs 280 may allow pins on the NIU 120 to act as inputs and outputs, as desired.

Aspects of the invention may even be wholly are partially implemented utilizing existing microcontrollers. Atmel® Corporation (San Jose, Calif., USA), as just one example, manufactures microcontrollers containing both UART and CAN network interfaces.

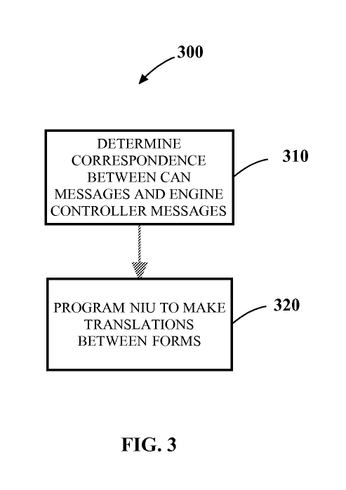

Methods according to illustrative embodiments of the invention allowing the NIU 120 to act as an interface in the data communication network 100 are now set forth with reference to FIGS. 3-5. FIG. 3, for example, shows an illustrative method 300 for initially configuring the NIU 120. In step 310, corresponding CAN messages are determined for each of several messages that may be generated by the engine controller 110. In a similar manner, corresponding engine controller messages are also determined for each of several CAN messages that may be generated by the ECUs 140, 150 in the CAN network 130. These determined sets of corresponding messages at least partially constitute a means for translating engine controller messages into CAN messages, and vice versa. Such translations may be determined for, as just a few examples, messages related to engine speed, engine temperature, check engine light activation, and the like.

The manner in which CAN messages relating to different subsystems and parameters are formatted in a particular CAN-based automobile may be determined empirically if that information is not available from other sources. Such an empirical determination may involve, for example, monitoring the CAN network of a stock automobile in real time while manipulating various subsystems and controls of that automobile. Engine speed, transmission gear position, hand brake position, throttle position, cruise control status, etc. may, as just a few examples, all be altered while watching the CAN messaging in real time. By watching the CAN messaging change as a function of what is being altered, appropriate CAN messages may be identified for each such parameter. Similar empirical studies may also be performed for non-OEM components to determine appropriate network message formats for parameters related to those components.

The determined translations between the CAN messages and the engine controller messages are then programmed into the NIU 120 in step 320 so that the NIU 120 may make the transformations therebetween. The translations may be, for example, implemented in the NIU 120 by way of one or more algorithms, one or more lookup tables, or a combination thereof. Where it is determined that a particular engine controller message need not be retransmitted on the CAN network 130, the translation of that particular message may be implemented to produce a result which causes the NIU 120 to ignore the message (i.e., produce no corresponding output for that input). Likewise, where it is determined that particular messages initiated by the ECUs 140, 150 in the CAN network 130 need not be retransmitted to the engine controller 110, the NIU 120 may be programmed to also ignore those messages, thereby causing the NIU 120 to only retransmit messages relevant to the engine controller 110.

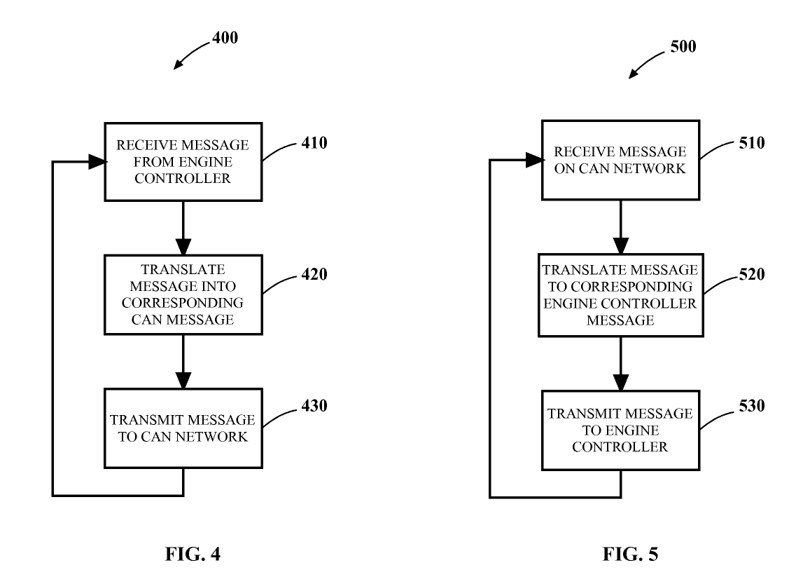

Once so programmed, the NIU 120 may then be in condition to operate as a network interface between the engine controller 110 and the CAN network 130. FIG. 4, for example, shows a flow chart of an illustrative method 400 that allows the NIU 120 to handle messages generated by the engine controller 110. In step 410, a message is received by the NIU 120 from the engine controller 110 via the NIU's UART 270. The NIU 120 then advances to step 420, wherein the engine controller message is translated into a corresponding CAN message, assuming the message is not ignored as described above. Lastly, in step 430, the NIU 120 transmits the translated engine controller message, now a CAN message, onto the CAN network 130 via the CAN interface 260.

In a similar manner, method 500 in FIG. 5 describes how the NIU 120 may handle messages generated by the ECUs 140, 150 in the CAN network 130. In step 510, a message is received by the NIU 120 from the CAN network 130 via the NIU's CAN interface 260. The NIU 120 then advances to step 520, wherein the CAN message is translated into a corresponding engine controller message, again assuming the message is not ignored as described above. Lastly, in step 530, the NIU 120 transmits the translated CAN message, now an engine controller message, to the engine controller 110 via the UART 270.

Optionally, the NIU 120 may also be programmed to generate scheduled CAN and/or engine controller messages autonomously, that is, without receiving an input message and translating that message first. This may be an important option in, for example, suppressing instrument cluster faults and other CAN faults. Notably, such an option gives aspects of the invention even greater flexibility in allowing the installation of non-OEM components into automobiles with existing CAN networks. The manner of programming the NIU 120 to perform these “broadcast-only” functions will be readily apparent to one skilled in the art. Such messages may, for example, be broadcast every so many clock cycles.

Aspects of the invention were successfully implemented in a 1998 Model XJ8 automobile from JAGUAR (Whitley, Coventry, UK) utilizing a 1998 Model LS1 V-8 engine from GENERAL MOTORS Company (Detroit, Mich., USA). The engine included an engine controller with a J1850 Class 2 serial output while the automobile included several CAN networks. After implementation, both the engine and the remainder of the automobile functioned reliably and without errant fault messages or other anomalies.

It should again be emphasized that the above-described embodiments of the invention are intended to be illustrative only. Other embodiments can use different types and arrangements of elements, or different methods, for implementing the described functionality. These numerous alternative embodiments within the scope of the invention will also be apparent to one skilled in the art. For example, apparatus and methods in accordance with aspects of the invention may also be operable to interface non-OEM equipment including ECUs having CAN networking capabilities with an existing CAN network in an automobile. In this manner, aspects of the invention may act as an interface between two CAN networks with dissimilar messaging protocols.

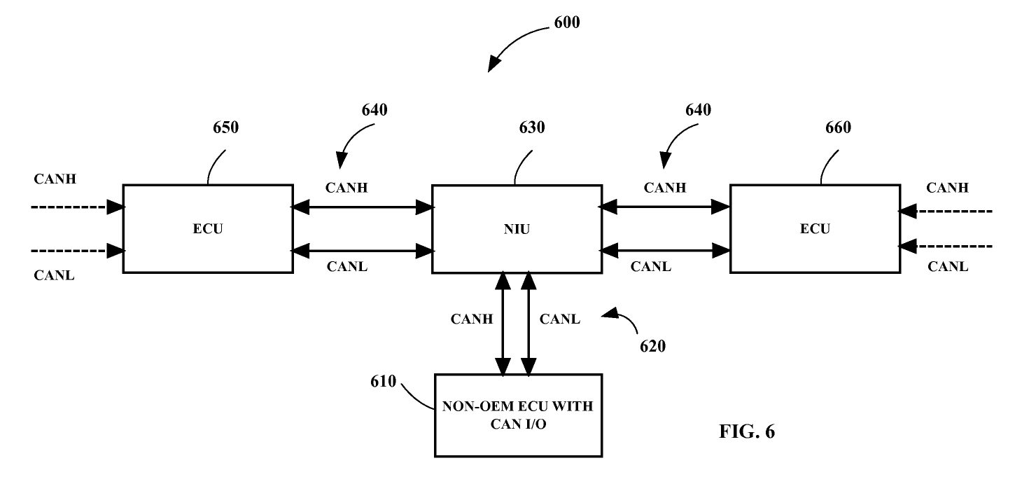

FIG. 6 shows a block diagram of at least a portion of a data communication network 600 within an automobile in accordance with a second illustrative embodiment of the invention. Here, the data communication network 600 is configured to accommodate a non-OEM ECU 610 with a CAN interface that is acting to manage a non-OEM engine within the vehicle. The non-OEM ECU 610 effectively forms a first CAN network 620 with a first messaging protocol. A NIU 630, in turn, interfaces this first CAN network 620 with a second CAN network 640 having a second messaging protocol. The second CAN network 640 ties together several ECUs, of which, only a first ECU 650 and a second ECU 660 are explicitly shown.

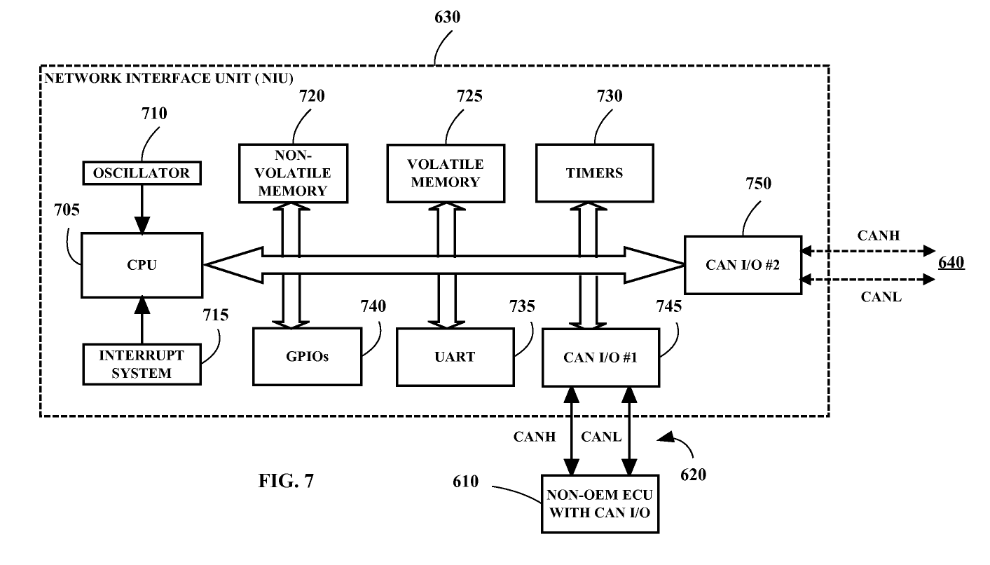

FIG. 7 shows a block diagram of several elements that may be found within a NIU 630, in accordance with an illustrative embodiment of the invention. Like the NIU 120, the NIU 630 comprises a CPU 705, an oscillator source 710, an interrupt system 715, a nonvolatile memory 720, a volatile memory 725, timers 730, a UART 735, and GPIOs 740. However, unlike the NIU 120, the NIU 630 in the present embodiment comprises a first CAN interface 745 and a second CAN interface 750. The first CAN interface 745 is tied to the first CAN network 620 (i.e., the non-OEM ECU 610), while the second CAN interface 750 is tied to the second CAN network 640 (i.e., ECUs 650 and 660).

The NIU 630 may be configured and may be operated in a manner similar to the NIU 120, except that the NIU 630 is now interfacing two CAN networks rather than interfacing a serial port network with a CAN network as was the case for the NIU 120. The NIU 630 may, for example, be programmed to perform translations between the first and second messaging protocols utilizing a method similar to the method 300, and may ultimately be operated using methods similar to the methods 400 and 500. Because of these strong similarities, aspects of the configuration and operation of the NIU 630 need not be detailed herein, but would be understood by one skilled in the art in light of the more detailed description of the NIU 120.

What is more, while serial port and CAN-type networks are set forth in the embodiments described above, one skilled in the art will recognize that alternative network technologies may be substituted for these particular technologies and the results will still come within the scope of the invention. Alternative network technologies include, as just few examples, USB, Ethernet, IEEE 1394, T1, and others.

In closing, it should be emphasized that all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. An apparatus for use with a vehicle having a first electronic control unit and a second electronic control unit, the apparatus comprising:
data processing circuitry;
memory circuitry, the memory circuitry in data communication with the data processing circuitry; and
input/output circuitry, the input/output circuitry in data communication with the data processing circuitry;
wherein the data processing circuitry, the memory circuitry, and the input/output circuitry are collectively operative to:
(a) receive an input message from the first electronic control unit over a first network, the input message formatted in conformity with a first messaging protocol;
(b) translate the input message into a corresponding output message formatted in accordance with a second messaging protocol, the second messaging protocol different from the first messaging protocol; and
(c) transmit the corresponding output message to the second electronic control unit over a second network;
wherein the first electronic control unit is operative to control and/or sense one or more first elements within the vehicle, and the second electronic control unit is operative to control and/or sense one or more second elements within the vehicle.

2. The apparatus of claim 1, wherein the first network comprises a serial port network, and the second network comprises a controller area network.

3. The apparatus of claim 1, wherein the first and second networks each comprise a respective controller area network.

4. The apparatus of claim 1, wherein the apparatus comprises a microcontroller.

5. The apparatus of claim 1, wherein step (b) is performed at least in part by reference to a lookup table.

6. The apparatus of claim 5, wherein the lookup table is populated at least in part by operating an element on the vehicle and detecting a corresponding message indicative of that operation on a network of the vehicle.

7. The apparatus of claim 1, wherein the input/output circuitry comprises serial port input/output circuitry.

8. The apparatus of claim 1, wherein the input/output circuitry comprises controller area network input/output circuitry.

9. The apparatus of claim 1, wherein the first electronic control unit controls at least a portion of an engine, and the second electronic control unit controls at least a portion of at least one of a transmission, one or more brakes, and an instrument cluster.

10. A vehicle, the vehicle comprising:
data processing circuitry;
memory circuitry, the memory circuitry in data communication with the data processing circuitry;
input/output circuitry, the input/output circuitry in data communication with the data processing circuitry;
a first electronic control unit, the first electronic control unit operative to control and/or sense one or more first elements within the vehicle; and
a second electronic control unit, the second electronic control unit operative to control and/or sense one or more second elements within the vehicle;
wherein the data processing circuitry, the memory circuitry, and the input/output circuitry are collectively operative to:
(a) receive an input message from the first electronic control unit over a first network, the input message formatted in conformity with a first messaging protocol;
(b) translate the input message into a corresponding output message formatted in accordance with a second messaging protocol; and
(c) transmit the corresponding output message to the second electronic control unit over a second network.

11. The vehicle of claim 10, wherein the first network comprises a serial bus network, and the second network comprises a controller area network.

12. The vehicle of claim 10, wherein the first and second networks each comprise a respective controller area network.

13. The vehicle of claim 10, wherein the apparatus comprises a microcontroller.

14. The vehicle of claim 10, wherein step (b) is performed at least in part by reference to a lookup table.

15. The vehicle of claim 14, wherein the lookup table is populated at least in part by operating an element on the vehicle and detecting a corresponding message indicative of that operation on a network of the vehicle.

16. The vehicle of claim 10, wherein the input/output circuitry comprises serial port input/output circuitry.

17. The vehicle of claim 10, wherein the input/output circuitry comprises controller area network input/output circuitry.

18. The vehicle of claim 10, wherein the first electronic control unit controls at least a portion of an engine, and the second electronic control unit controls at least a portion of at least one of a transmission, one or more brakes, and an instrument cluster.

19. A method for controlling a vehicle having a first electronic control unit and a second electronic control unit, the method performed by data processing circuitry in data communication with memory circuitry and input/output circuitry, the method comprising the steps of:
(a) receiving an input message from the first electronic control unit over a first network, the input message formatted in conformity with a first messaging protocol;
(b) translating the input message into a corresponding output message formatted in accordance with a second messaging protocol, the second messaging protocol different from the first messaging protocol; and
(c) transmitting the corresponding output message to the second electronic control unit over a second network;
wherein the first electronic control unit is operative to control and/or sense one or more first elements within the vehicle, and the second electronic control unit is operative to control and/or sense one or more second elements within the vehicle.
